(19) United States
(12) Patent Application Publication
(10) Pub. No.: US 2015/0131260 A1
(43) Pub. Date: May 14, 2015

(54) LIGHT-EMITTING DEVICE COMPRISING A HOLLOW RETRO-REFLECTOR

(71) Applicant: KONINKLIJKE PHILIPS N.V., EINDHOVEN (NL)

(72) Inventors: Martinus Hermanus Wilhelmus Maria Van Delden, Venlo (NL); Leon Wilhelmus Godefridus Stofmeel, Eindhoven (NL)

(73) Assignee: KONINKLIJKE PHILIPS N.V., EINDHOVEN (NL)

(21) Appl. No.: 14/405,620

(22) PCT Filed: May 24, 2013
(86) PCT No.: PCT/IB2013/054291

§ 371 Date: Dec. 4, 2014

Related U.S. Application Data
(60) Provisional application No. 61/657,111, filed on Jun. 8, 2012.

(51) Int. Cl. F21V 7/04; F21K 99/00; F21V 13/10

(52) U.S. Cl. CPC F21V 7/04; F21V 13/10; F21K 9/50; F21K 9/56; F21Y 2101/02
USPC 362/84; 362/231; 362/235; 362/241; 362/297

(57) ABSTRACT

The present invention relates to a light-emitting device (11) comprising a hollow retro reflector (15) having a reflective internal surface comprising at least three surface segments (17a-c) connected at an apex (18); and a solid state light-source (16a-c) attached to said internal surface of the hollow retro reflector and arranged to emit light towards said apex of the hollow retro refector. Various embodiments of the present invention provide uniform light-output from a relatively simple and cheap light-emitting device.

### FIELD OF THE INVENTION

The present invention relates to a light-emitting device and to a method of manufacturing such a light-output device.

### BACKGROUND OF THE INVENTION

With the recent development of energy efficient solid state light-sources, such as light-emitting diodes (LEDs), this type of light-sources are being used for many different types of applications.

At least for some applications, it is desirable to achieve a uniform light output, sometimes across a relatively large area.

Aiming to provide uniform light output, US-20110031518 discloses an LED device with an LED and a special type of reflector arranged in a stack on the light-emitting surface of the LED. However, the solution according to US-20110031518 appears to be relatively complicated and potentially expensive.

### SUMMARY OF THE INVENTION

In view of the above-mentioned and other drawbacks of the prior art, a general object of the present invention is to provide an improved light-output device, in particular providing for a simpler way of achieving a uniform light output.

According to a first aspect of the present invention there is provided a light-emitting device comprising a hollow retro reflector having a reflective internal surface comprising at least three surface segments connected at an apex; and a solid state light-source attached to the hollow retro reflector and arranged to emit light towards the apex of the hollow retro reflector.

Solid state light-sources are light-sources in which light is generated through recombination of electrons and holes. Examples of solid state light-sources include LEDs and semiconductor lasers.

The solid state light-source may advantageously be attached to the internal surface of the hollow retro reflector.

The present invention is based on the realization that a light-emitting device with a uniform light output can be achieved by arranging one or several solid state light-source(s) on the internal surface of a hollow retro reflector in such a way that the solid state light-source(s) emit(s) light towards the apex of the hollow retro reflector when itthey isare operated. Depending on the configuration of the hollow retro reflector and the positioning of the solid state light-source(s) a light-emitting device with a more or less Lambertian emission profile can be achieved. The present inventors have further realized that a light-emitting device comprising a hollow retro reflector and at least one solid state light-source attached to the internal surface of the hollow retro reflector can be manufactured in a very rational and cost-efficient manufacturing process. For example, a large number of solid state light-sources may simultaneously be attached to a reflective sheet, which may then be separated into a plurality of light-emitting device blanks, which can be formed, for example by folding, to a plurality of light-emitting devices, each comprising a hollow retro reflector and at least one solid state light-source attached to the internal surface of the hollow retro reflector.

Accordingly, various embodiments of the present invention provide uniform light-output from a relatively simple and cheap light-emitting device.

The at least three surface segments of the reflective internal surface of the hollow retro reflector may have any configuration, but may advantageously be substantially planar in order to facilitate production.

Accordingly, the hollow retro reflector may advantageously have a polygonal cross-section.

According to various embodiments of the light-emitting device of present invention, the surface segments of the hollow retro reflector may be triangular surface segments, each having its vertex at the apex of the hollow retro reflector.

Moreover, each of the surface segments may be arranged at substantially right angles in respect of surface segments adjacent to said surface segment, such that the hollow retro reflector is shaped as a so-called corner cube retro reflector. The reflective internal surface of a corner cube type hollow retro reflector has three triangular surface segments, each having a vertex angle of 90 degrees. Through such a corner cube configuration, excellent uniformity can be achieved and manufacturing is relatively simple.

According to various embodiments, the at least three surface segments of the reflective internal surface of the hollow retro reflector may have substantially the same geometrical shape, which may facilitate manufacturing of the light-emitting device, in particular since an optimum arrangement of the solid state light-source(s) may be easier to determine and/or achieve.

Furthermore, the at least one solid state light-source comprised in the light-emitting device according to various embodiments of the invention may be arranged such that a projection of the optical axis of the solid state light-source on one of the surface segments of the hollow retro reflector passes through the apex of the hollow retro reflector. Such a positioning of the solid state light-source(s) will result in a uniform light output of the light-emitting device.

In embodiments of the present invention where the surface segments of the reflective internal surface of the hollow retro reflector are triangular, the hollow retro reflector may have a triangular base opposite the apex of the hollow retro reflector. For such embodiments, the solid state light-source(s) may advantageously be arranged along an altitude of the triangular base of the hollow retro reflector. Such an arrangement of the solid state light-source(s) will further improve the light output uniformity.

To prevent or at least reduce the risk of a user getting a direct view of the solid state light-source(s), embodiments of the light-emitting device according to the present invention may comprise a light shield arranged to shield the solid state light-source(s) from direct view.

This light-shield may be formed by a further segment of the reflective internal surface of the hollow retro reflector.

To further improve the light output uniformity, the reflective internal surface of the hollow retro reflector may be at least partially diffusely reflecting.

Moreover, to provide for output of color converted light (for example blue light converted into white light), the reflective internal surface of the hollow retro reflector may comprise a wavelength converting material. Examples of such wavelength converting materials, which are well known in the art, include so-called organic phosphors and inorganic phosphors. Such a remote phosphor coating or film is very efficient for, for example, converting blue light (which may originate from a blue LED) to white light.

According to one embodiment, the reflective internal surface of the hollow retro reflector may comprise a first wavelength converting material and a second wavelength converting material having wavelength conversion properties that are different from those of the first wavelength converting material. Additional wavelength converting materials having different wavelength conversion properties may also be provided. By arranging wavelength converting materials having different wavelength conversion properties according to a predefined configuration on the internal surface of the hollow retro reflector, it will be possible to achieve different color points depending on the origin of the light to be converted (position of the solid state light source), even if the light to be converted is of the same color. For example, an embodiment of the light-emitting device may comprise a plurality of solid state light-sources each being arranged on a different respective surface segment of the reflective internal surface of the hollow retro reflector. Then, differently colored light can be output by adjusting the relative intensities of the individual solid state light-sources, even if the solid state light-sources were to emit light of the same color.

According to further embodiments, the light-emitting device may further comprise an optical diffuser arranged such that light reflected by the hollow retro reflector passes through said optical diffuser after exiting the hollow retro reflector. The optical diffuser may be provided in different shapes. For example, the optical diffuser may be provided in the form of a film, or as a three-dimensional hollow body. In addition to being capable of diffusing/scattering light, the optical diffuser may comprise a wavelength converting material, such as a so-called remote phosphor.

Moreover, the light-emitting device according to various embodiments of the present invention may advantageously comprise a plurality of solid state light-sources each being arranged on a respective one of the surface segments of the reflective internal surface of the hollow retro reflector and being arranged to emit light towards the apex of the hollow retro reflector. Through proper placement of the solid state light-sources, the (spatial) light emission profile from the light-emitting device can be made substantially independent on which of the solid state light-sources is operating and/or how many of the solid state light-sources are operating. This may conveniently allow for increments in the intensity of uniform light output from the light-emitting device or output of uniform light of different colors in the case when the solid state light-sources are differently colored.

Both for the case with solid state light-sources that all have the same color and for the case when differently colored solid state light-sources are used (and when the light-emitting device is provided with a single solid state light-source), the hollow retro reflector may have many different configurations depending on the requirements of the particular application for which the light-emitting device is to be used. For example, the hollow retro reflector may have a triangular cross-section, which allows for the use of three different base colors, such as red (R), green (G) and blue (B), or yellow (Y), magenta (M) and cyan (C), etc. To further increase the color gamut and/or provide for more saturated colors, the hollow retro reflector may comprise a larger number of surface segments. For example, the hollow retro reflector may have a rectangular cross-section with the light-source configuration RGBW, or the hollow retro reflector may have a hexagonal cross-section with the light-source configuration RGBYMC etc. Of course, several other configurations of the hollow retro reflector and/or light-source configurations are possible and readily achievable by one of ordinary skill in the art.

Moreover, a plurality of light-emitting devices according to various embodiments of the present invention may be comprised in a light-output device, further comprising a diffuser layer arranged to diffuse light emitted by the light-emitting devices. The light-emitting devices may advantageously be arranged in a two-dimensional array. The light-output device may, for example, be a large area lighting panel, which may, for example, be used as a building element.

According to a second aspect of the present invention, there is provided a method of manufacturing a light-emitting device comprising the steps of: providing a sheet having a reflective side; arranging at least one solid state light-source on the reflective side of the sheet to form at least one light-emitting device blank; and shaping the light-emitting device blank to a hollow retro reflector in such a way that the reflective side of the sheet becomes an internal surface of the hollow retro reflector and the solid state light-source is arranged to emit light towards an apex of the hollow retro reflector.

The sheet used in the manufacture of the light-emitting device may comprise electrodes and contact pads for electrical connection of the at least one solid state light-source. Alternatively, the electrical connection to the solid state light-source(s) may be achieved through other means, such as separate electrical conductors or electrical conductors that are pre-attached to the solid state light-source(s).

Furthermore, the sheet may be made of a reflective material and/or may be coated with a reflective material.

The light-emitting device blank may, for example, be shaped to a hollow retro reflector by folding the light-emitting device blank along fold lines. It should, however, be understood that the light-emitting device blank need not necessarily be folded in order to be shaped into a hollow retro reflector. Depending on the particular configuration of the light-emitting device blank, it could also be molded or pressed into the desired hollow retro reflector shape.

According to various embodiments, the step of attaching may comprise attaching a plurality of solid state light-sources arranged in an array configuration to the sheet to form a composite structure comprising a plurality of light-emitting device blanks; and the method may then further comprise the step of separating the composite light-source structure into the plurality of light-emitting device blanks. The light-emitting device blanks are then shaped into hollow retro reflectors.

Further variations and advantages of this second aspect of the present invention are largely analogous to those provided above in connection with the first aspect of the invention.

### BRIEF DESCRIPTION OF THE DRAWINGS

These and other aspects of the present invention will now be described in more detail, with reference to the appended drawings showing currently preferred embodiments of the invention, wherein:

FIG. 1 schematically shows an exemplary application of the light-emitting device according to various embodiments of the present invention, in the form of a light-emitting panel arranged in a ceiling, the light-emitting panel comprising a plurality of light-emitting devices;

FIG. 2 is a schematic perspective cutaway view of the light-emitting panel in FIG. 1;

FIG. 3 is a perspective view of one of the light-emitting devices in FIG. 2;

FIG. 4a is a plane view of a first embodiment of the light-emitting device in FIG. 3;

FIG. 4b is a plane view of a second embodiment of the light-emitting device in FIG. 3;

FIG. 5 is a flow-chart illustrating a manufacturing method according to an embodiment of the present invention; and

FIGS. 6a-d schematically illustrate the result of the corresponding steps of the method of FIG. 5.

### DESCRIPTION OF A PREFERRED EMBODIMENT OF THE PRESENT INVENTION

In the following description, the present invention is mainly described with reference to a light-emitting device comprising a hollow retro reflector in the form of a symmetric corner cube retro reflector with one side-emitting LED arranged on each reflective segment of the hollow retro reflector.

It should, however, be noted that this by no means limits the scope of the invention, which is equally applicable to, for example, light-emitting devices with differently shaped hollow retro reflectors and other configurations of the solid state light-sources. For instance, the hollow retro reflector need not be a corner cube, but may have other cross-sections, such as a rectangular cross-section, a hexagonal cross-section etc.

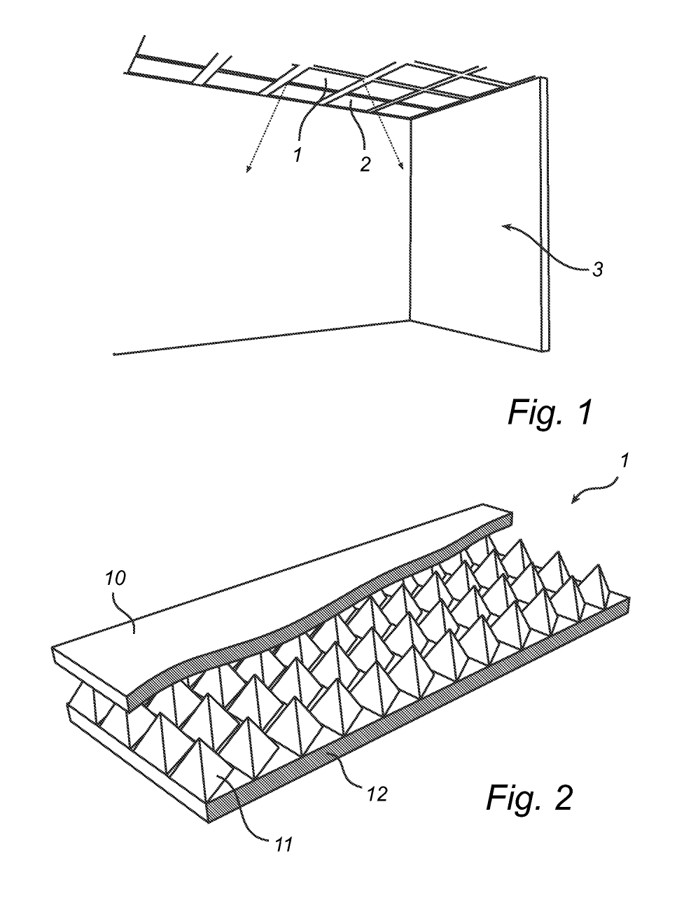

FIG. 1 schematically illustrates an exemplary application for embodiments of the light-emitting device according to the present invention, in the form of a light-emitting panel 1 arranged in a ceiling 2 of a room 3. The light-emitting panel 1 may be intended as daylight replacement and should then emit uniform white light.

With reference to FIG. 2, which is a schematic perspective cutaway view of the light-emitting panel in FIG. 1, the light-emitting panel 1 comprises a base structure 10, a plurality of light-emitting devices 11 and a diffusing sheet (or remote phosphor film) arranged in front of the light-emitting devices to diffuse light emitted by the light-emitting devices 11. Through the arrangement of FIG. 2, a uniform light output can be achieved across a relatively large area. It should be noted that FIG. 2 is a simplified illustration of the light-emitting panel 1 in FIG. 1, and that various structures, such as electrical connections to the light-emitting devices 11 and structures for mounting the light-emitting panel 1 in the ceiling 2, are not explicitly indicated. Such structures can, however, be provided in many different ways apparent to one skilled in the art.

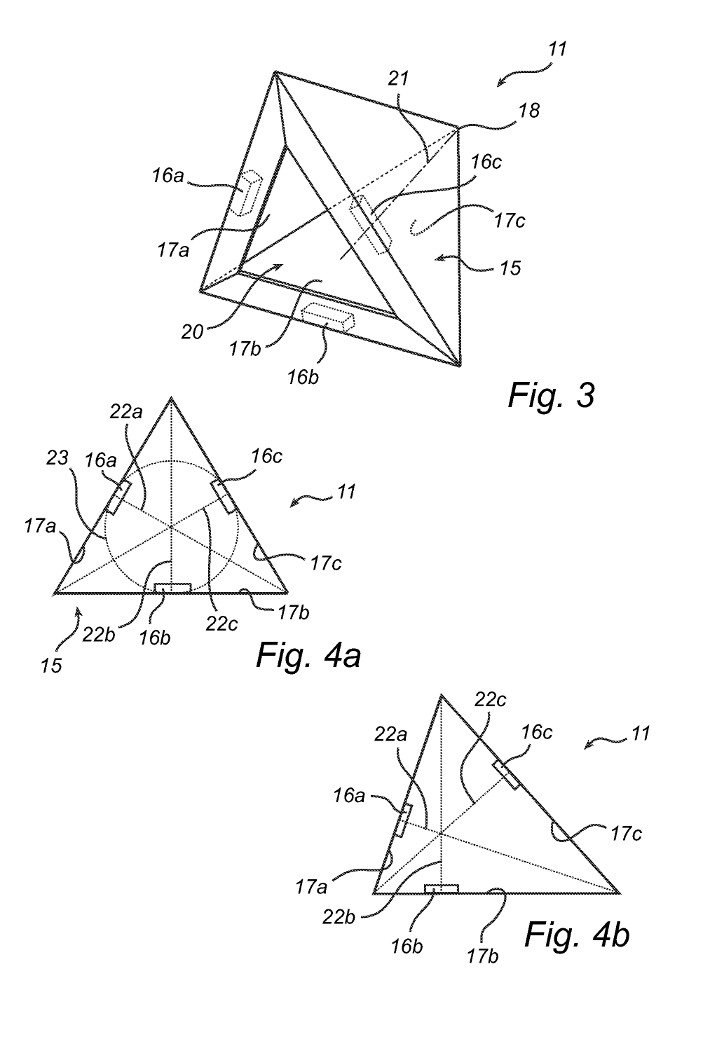

The light-emitting devices 11 will now be described in greater detail with reference to FIG. 3. As is schematically indicated in FIG. 3, the light-emitting device 11 comprises a hollow retro reflector 15 of the corner cube type and a three light-emitting diodes (LEDs) 16a-c. The hollow retro reflector 15 has a reflective internal surface comprising three surface segments 17a-c all connected at an apex 18 of the hollow retro reflector 15. The light-emitting device 11 additionally comprises light shields for preventing or at least reducing the risk of direct view of the LEDs 16a-c. In the particular embodiment illustrated in FIG. 3, the light-shields are provided in the form of further surface segments 19a-c of the hollow retro reflector 15. Moreover, the hollow retro reflector 15 has a triangular base 20 opposite the apex 18, and the LEDs 16a-c are arranged at the base 20 as will be described further below with reference to FIGS. 4a and 4b. Furthermore, as is schematically indicated for one of the LEDs 16c, the optical axis 21 of the LED 16c is directed towards the apex 18 of the hollow retro reflector 15.

Through the configuration of the light-emitting device 11 in FIG. 3, a uniform light output through the base 20 of the hollow retro reflector 15 will be achieved for any driving setting of the three LEDs 16a-c. According to one embodiment, the three LEDs 16a-c may comprise a red (R) LED, a green (G) LED and a red (R) LED. By controlling the output of each of the differently colored LEDs, uniform light across the color gamut defined by the three LEDs can be output by the light-emitting device 11.

According to another embodiment, the three LEDs 16a-c may have the same emission characteristics (for example blue LEDs) and the three surface segments 17a-c may be coated with wavelength converting materials having different wavelength conversion properties. Also for this embodiment, the output of the light-emitting device can be controlled across a color gamut by controlling the output of each of the (substantially identical) LEDs. For this embodiment, the color gamut is defined by the properties and configurations of the wavelength converting materials provided on the internal surface of the hollow retro reflector 15. Of course, many other variations are possible and may be favorable depending on the application. For instance, differently colored LEDs and different wavelength converting materials may be combined.

The LEDs 16a-c may be arranged in different locations inside the hollow retro reflector 15 as long as they emit light towards the apex 18 of the hollow retro reflector when in operation. For optimum uniformity of the light output from the light-emitting device 11, it is, however, beneficial if each LED 16a-c is arranged along a respective altitude 22a-c of the triangular base 20 of the hollow retro reflector 15 as is schematically indicated in FIG. 4a for the case with a regular triangular base and in FIG. 4b for the case with an irregular triangular base. FIG. 4a also includes an inscribed circle 23, and as can be seen in FIG. 4a, the LEDs 16a-c are arranged at the points where the circle is tangent to the regular triangular base 20 of the hollow retro reflector. This LED-placement (at the tangent points of an inscribed circle) is also valid for other configurations of the hollow retro reflector 15 with a base 20 in the form of a regular polygon.

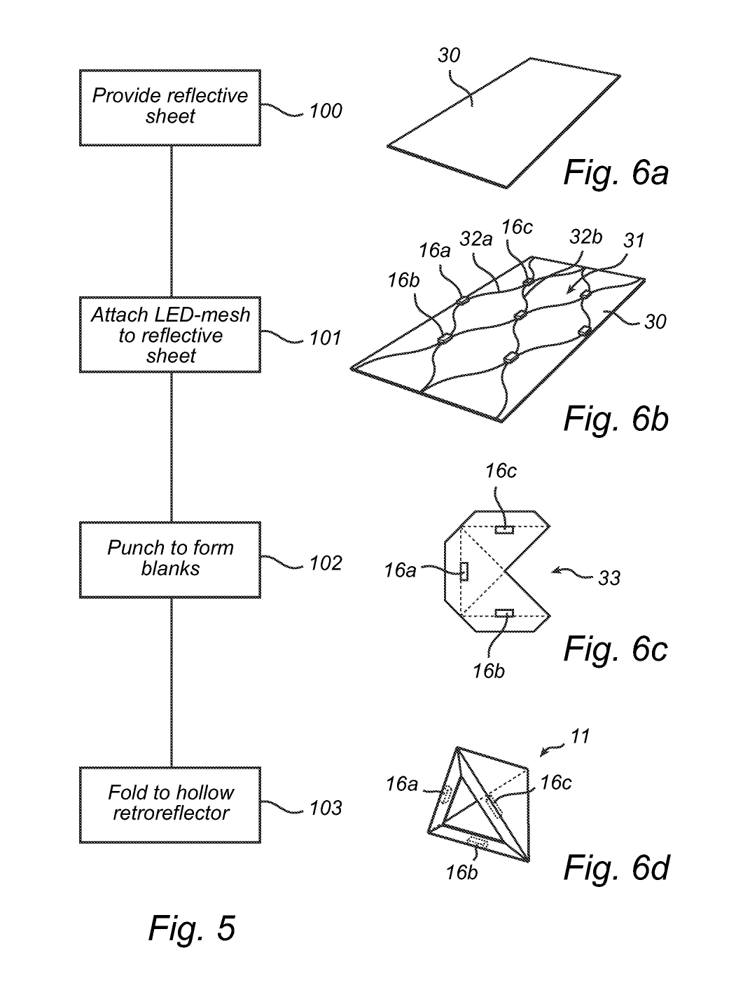

Finally, an exemplary method of manufacturing the light-emitting device 11 in FIG. 3 will be described below with reference to the flow-chart in FIG. 5 and FIGS. 6a-d.

In a first step 100, a reflective sheet 30 is provided.

In the next step 101, an LED-mesh 31 is attached to the reflective sheet 30. The LED-mesh comprises a plurality of LEDs 16a-c and electrical conductors 32a-b for electrical connection to the LEDs. In the presently illustrated example, the LED-mesh 31 is attached to the reflective side of the reflective sheet 30. Alternatively, the LED-mesh 31 may be attached to the back side of the reflective sheet and holes for the LEDs 16a-c may be provided in the reflective sheet 30.

Subsequently, in step 102, the composite structure comprised of the reflective sheet 30 and the LED-mesh 31 is cut or punched to form a plurality of light-emitting device blanks 33.

These blanks 33 are finally, in step 103, folded to a hollow retro reflector, in this case a corner cube type hollow retro reflector.

Additionally, variations to the disclosed embodiments can be understood and effected by the skilled person in practicing the claimed invention, from a study of the drawings, the disclosure, and the appended claims. For example, the light-emitting device may comprise an optical diffuser, which may comprise one or several wavelength converting material(s). Moreover, one or several light-emitting devices may be arranged inside a diffusing bulb.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light-emitting device comprising:
a hollow retro reflector having a reflective internal surface comprising at least three surface segments connected at an apex; and
a solid state light-source,
wherein the solid state light-source is for emitting light towards the apex of the hollow retro reflector by being arranged on a respective one of the surface segments such that a projection of its optical axis on the respective one of the surface segments passes through the apex.

2. The light-emitting device according to claim 1, wherein said surface segments of the hollow retro reflector are triangular surface segments, each having its vertex at said apex of the hollow retro reflector.

3. The light-emitting device according to claim 1, wherein each of said surface segments is arranged at substantially right angles in respect of surface segments adjacent to said surface segment.

4. The light-emitting device according to claim 1, wherein said at least three surface segments have substantially the same geometrical shape.

5. (canceled)

6. The light-emitting device according to claim 2, wherein said hollow retro reflector has a triangular base opposite said apex, and said solid state light source is arranged along an altitude of said triangular base of the hollow retro reflector.

7. The light-emitting device according to claim 1, further comprising a light shield arranged to shield said solid state light-source from direct view.

8. The light-emitting device according to claim 7, wherein said light shield is formed by a further segment of said reflective internal surface of the hollow retro reflector.

9. The light-emitting device according to claim 1, wherein said reflective internal surface of the hollow retro reflector is at least partially diffusely reflecting.

10. The light-emitting device according to claim 1, wherein said reflective internal surface of the hollow retro reflector comprises a wavelength converting material.

11. The light-emitting device according to claim 1, further comprising an optical diffuser arranged such that light reflected by said hollow retro reflector passes through said optical diffuser.

12. The light-emitting device according to claim 1, comprising a plurality of solid state light-sources, wherein each solid state light-source is for emitting light towards the apex of the hollow retro reflector by being arranged on a respective one of said surface segments of the reflective internal surface of the hollow retro reflector such that a projection of its optical axis on the respective one of the surface segments passes through the apex.

13. The light-emitting device according to claim 12, wherein each of said solid-state light-sources is configured to emit differently colored light.

14. A light-output device comprising:
a plurality of light-emitting devices according to claim 1 arranged in a two-dimensional array; and
a diffuser layer arranged to diffuse light emitted by said light-emitting devices.

15. (canceled)
